(19) United States
(12) Patent Application Publication
(10) Pub. No.: US 2026/0149245 A1
(43) Pub. Date: May 28, 2026

(54) CRIMPING TOOL LOCATOR PLATE

(71) Applicant: Hubbell Incorporated, Shelton, CT (US)

(72) Inventor: Jeffrey Castellano O'Neill, Melrose, MA (US)

(21) Appl. No.: 19/386,801

(22) Filed: Nov. 12, 2025

Related U.S. Application Data
(60) Provisional application No. 63/726,093, filed on Nov. 27, 2024.

(51) Int. Cl. H02G 1/14

(52) U.S. Cl. CPC H02G 1/14

(57) ABSTRACT

A locator plate assembly for use with a crimping device, the locater plate assembly including a main body and a locator plate pivotally attached to the main body.

### CROSS-REFERENCE TO RELATED APPLICATIONS

This application claims priority to U.S. Provisional Application Ser. No. 63/726,093 filed Nov. 27, 2024 the contents of which application are incorporated herein in their entirety by reference.

### TECHNICAL FIELD

The present disclosure relates to locator plates, and more specifically to crimping tool locator plates.

### DESCRIPTION OF THE RELATED ART

Crimping involves a process of connecting or terminating wires or cables with lugs, connectors, terminals, etc. utilizing tools specifically designed for this process. Various standards exist for crimping to achieve a safe and reliable electrical connection between the wires or cables and the lugs, connectors, terminals, etc. A proper crimp can withstand mechanical stress and environmental factors. Improper crimping can lead to unreliable electrical connections resulting in signal loss, data corruption and other system problems. An improper crimp may even result in increased resistance which can lead to overheating and in worse case fire.

Hand operated and hand-held battery-operated crimping tools are known in the art. Such tools are sometimes referred to as a pressing or a crimping tool and may generally have a pair of jaws. Hand operated crimping tools often include movable arms each including a jaw. Hand-held battery-operated crimping tools often include a fixed jaw and a movable jaw. Each jaw may include a permanent or replaceable die suitable for crimping terminations or connectors of one or more sizes to appropriately sized conductors. Using such tools, a conductor is placed within an electrical wire termination or connector which is then manually held in place between the pair of dies. Crimping of the electrical wire termination or connector is carried out. For a hand operated tool, this is performed by squeezing the arms of the tool toward each other. For a hand-held battery-operated tool, this is performed when a motor is activated causing the movable jaw to move toward the fixed jaw. The dies then impinge the termination or connector thus crimping the termination or connector to the conductor.

Alignment of the termination or connector within the tool dies is critical to obtaining the proper connection between the termination or connector and the conductor. Visually and manually aligning the termination or connector within the dies leaves room for human error which can result in an improper crimp and increases the overall time required per crimp.

Locator plates have been developed which may be screwed onto the crimping tool and are used to aid the user in properly locating the termination or connector within the dies. Such screw-on locator plates are generally held in position on the tool utilizing two or more screws. However, due to their rigid and static design, such screw-on locator plates do not work with every termination or connector combination available. Furthermore, while such locator plates are useful for crimping terminal connectors, the locator plate must be removed from the crimping tool in order to perform a butt splice crimp for crimping the ends of two or more conductors together. Accordingly, the user may be required to change or remove the locator plate based on the termination or connector being used. The user may thus be required to unscrew and re-fasten two or more screws holding the locator plate to the tool when a different termination or connector is to be used. This operation takes time and requires the user to carry additional tools and to handle/manage small hardware items in the process.

Accordingly, a need exists for a locator plate that may be easily removed and replaced as necessary and does not need to be removed from the tool when crimping certain types of connectors not requiring the use of a locator plate.

### SUMMARY OF THE INVENTION

The present disclosure provides exemplary embodiments of locator plates for use with crimping devices.

In one exemplary embodiment, a locator plate assembly for use with a crimping device is provided, the locater plate assembly including a main body and a locator plate pivotally attached to the main body.

In another exemplary embodiment, a quick release locator plate assembly for use with a crimping device is provided, the quick release locater plate assembly comprising a main body configured to attach to the crimping device and comprising a quick release mechanism and locator plate pivotally attached to the main body.

### BRIEF DESCRIPTION OF THE DRAWINGS

The figures depict embodiments for purposes of illustration only. One skilled in the art will readily recognize from the following description that alternative embodiments of the structures illustrated herein may be employed without departing from the principles described herein, wherein:

FIG. 1 is a side perspective view of a first side of an exemplary embodiment of a battery-powered tool utilizing a locator plate assembly according to an illustrative embodiment of the present disclosure;

FIG. 2 is an enlarge view of a portion of the battery-powered tool depicted in FIG. 1 utilizing a locator plate assembly according to an illustrative embodiment of the present disclosure;

FIG. 3 is a perspective view of a crimp connector and cable for describing a crimping operation according to illustrative embodiments of the present disclosure;

FIGS. 4-6 are side views of a portion of the battery-powered tool depicted in FIG. 1 utilizing the locator plate assembly according to an illustrative embodiment of the present disclosure for describing rotation of the locator plate into and out of a crimping position;

FIG. 7 is an exploded perspective view of a portion of the battery-powered tool depicted in FIG. 1 for describing attachment of the locator plate assembly to the tool according to an illustrative embodiment of the present disclosure;

FIG. 8 is an enlarged view of the locator plate assembly according to an illustrative embodiment of the present disclosure;

FIG. 9 is a cross-sectional view of a portion of the tool of FIG. 7 taken along lines 9-9 according to an illustrative embodiment of the present disclosure;

FIG. 10 is an exploded view of the locator plate assembly according to an illustrative embodiment of the present disclosure;

FIG. 11 is an enlarged side view of a portion of the battery-powered tool and locator plate assembly according to an illustrative embodiment of the present disclosure for describing various aspects of a crimping operation utilizing the tool and assembly;

FIG. 12 is an enlarged side view, opposite the view depicted in FIG. 11 and showing a portion of the battery-powered tool and locator plate assembly according to an illustrative embodiment of the present disclosure;

FIG. 13 is a perspective view of a portion of the battery-powered tool and a locator plate assembly according to another illustrative embodiment of the present disclosure;

FIG. 14 is an enlarged perspective view of the locator plate assembly depicted in FIG. 13 according to an illustrative embodiment of the present disclosure;

FIG. 15 is an exploded view of the locator plate assembly depicted in FIGS. 13 and 14 according to an illustrative embodiment of the present disclosure;

FIG. 16 is an enlarged side view of a portion of the battery-powered tool and locator plate assembly according to an illustrative embodiment of the present disclosure for describing various aspects of a crimping operation utilizing the tool and assembly;

FIG. 17 is an exploded perspective view of a portion of the battery-powered tool depicted in FIG. 1 for describing attachment of a locator plate assembly according to another illustrative embodiment of the present disclosure;

FIG. 18 is an enlarged exploded perspective view depicting a die and a portion of a locator plate assembly depicted in FIG. 17 according to an illustrative embodiment of the present disclosure;

FIG. 19 is a different enlarged exploded perspective view of the die and the portion of the locator plate assembly depicted in FIG. 17 according to an illustrative embodiment of the present disclosure;

FIG. 20 is an exploded view of the locator plate assembly depicted in FIG. 17 according to an illustrative embodiment of the present disclosure; and

FIG. 21 is an enlarged side view of a portion of the battery-powered tool and locator plate assembly according to an illustrative embodiment of the present disclosure for describing various aspects of a crimping operation utilizing the tool and assembly.

### DETAILED DESCRIPTION

The tools contemplated for use with embodiments of the present disclosure include a locator plate assembly for use with crimping tools that crimp various types of connectors to one or more conductors. Embodiments of the present disclosure will be shown and described in connection with portable, battery-powered, hand-held tools. However, it will be appreciated that aspects of the present disclosure may be applied to various types of crimping tools including non-battery-powered tools.

For ease of description, the crimping tools utilized with embodiments of the present disclosure may also be referred to as the “tools” in the plural and the “tool” in the singular. The objects crimped by the crimping tool may also be referred to herein as the “wire terminations” or “connectors” in plural and the “wire termination” of “connector” in the singular. Non-limiting examples of the wire terminations include lugs and splices. The conductors, cables, wires or objects to be crimped within the wire terminations by the tools of the present disclosure may also be referred to as the “conductors” in the plural and the “conductor” in the singular. The conductors may be single strand or multi strand type conductors. The locator crimping plates described herein may also be referred to as the “locator plates” in the plural and the “locator plate” in the singular.

In addition, as used in the present disclosure, the terms “front,” “rear,” “upper,” “lower,” “upwardly,” “downwardly,” “proximal,” “distal” and other orientation descriptors are intended to facilitate the description of the exemplary embodiments disclosed herein and are not intended to limit the structure of the exemplary embodiments or limit the claims to any particular position or orientation.

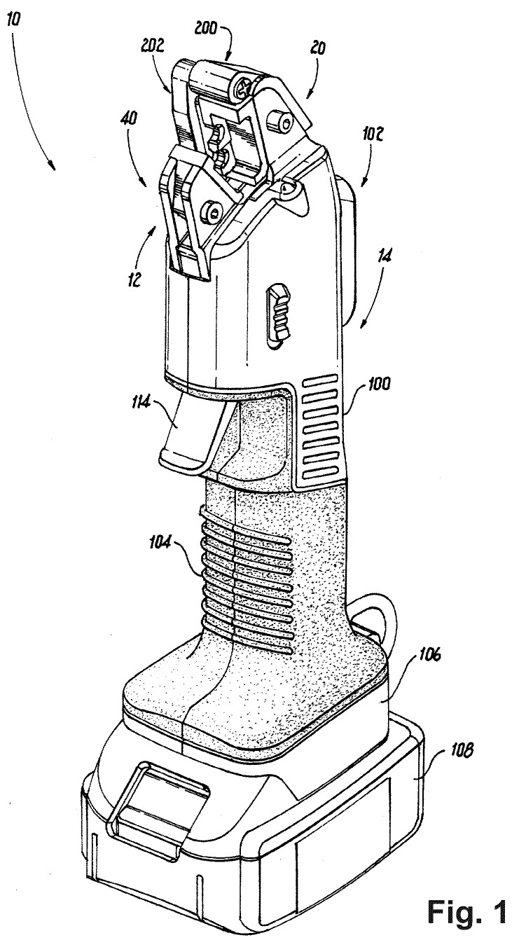

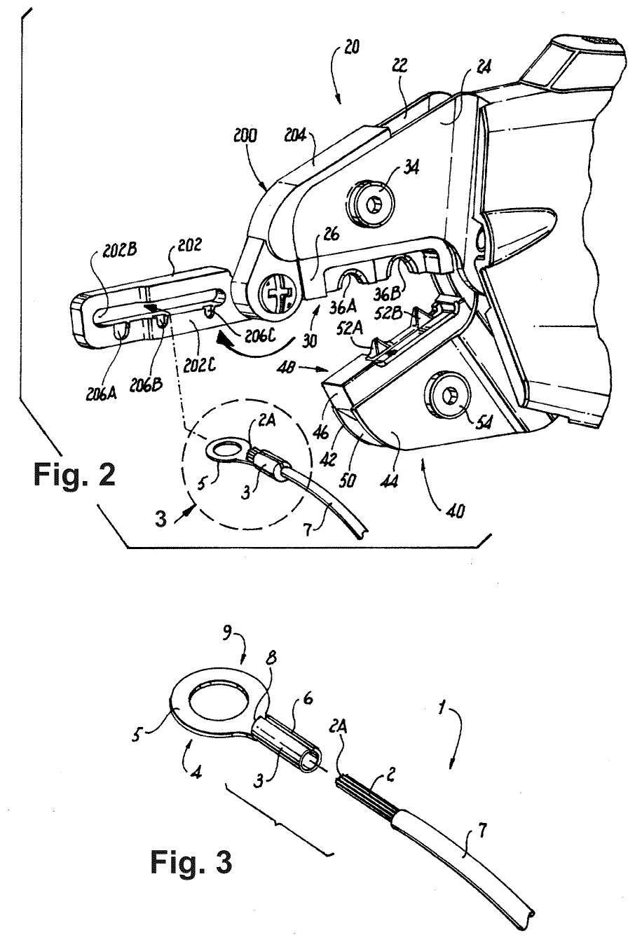

A battery-powered, hand-held crimping tool 10 that utilizes locator plates according to embodiments of the present disclosure is depicted in and will be described by reference to FIGS. 1 and 2. The tool 10 includes a working head assembly 12 and a handle assembly 14. The working head assembly 12 includes a first jaw assembly 20 and a second jaw assembly 40. A biasing member (not shown) may be used to automatically bias the second jaw assembly 40 in a direction away from the first jaw assembly 20. The first jaw assembly 20 includes a first jaw plate 22, a second jaw plate 24 and a die 26. The first jaw plate 22 and second jaw plate 24 are aligned in parallel and spaced apart, as shown. In this exemplary embodiment, the die 26 includes one or more impinging regions 30 and a mounting region 31 (e.g., see FIGS. 18 and 19) positioned between the first and second jaw plates 22, 24 and secured thereto by a bolt or fastener 34. As will be described in further detail later below, mounting region 31 is configured to mate with a locator plate assembly 200. Each of the one or more impinging regions 30 may include one or more impacting surfaces (36A, 36B), each surface being configured and dimensioned to receive the barrel portions of differently sized wire terminations or connectors. For example, impacting surface 36A may be shaped and dimensioned to receive the barrel portion of a termination or connector capable of receiving a conductor in the 14-22 gauge range. Impacting surface 36B may be shaped and dimensioned to receive the barrel portion of a termination or connector capable of receiving a conductor in the 10-12 gauge range. The second jaw assembly 40 includes a first jaw plate 42, a second jaw plate 44 and die 46. The first jaw plate 42 and second jaw plate 44 are aligned in parallel and spaced apart, as shown. In this exemplary embodiment, the die 46 includes one or more impinging regions 48 and a mounting region 50 positioned between the first and second jaw plates 42, 44 and secured thereto by a bolt or fastener 54. Each of the one or more impinging regions 48 may include one or more impacting surfaces (52A, 52B), each surface being configured and dimensioned to impinge upon the barrel portions of the connectors or terminations positioned in the corresponding impacting surfaces (36A, 36B).

The second jaw assembly 40 is operatively coupled to the first jaw assembly 20 so that the second jaw assembly 40 is movable relative to the first jaw assembly 20. That is, the second jaw assembly 40 pivots relative to the first jaw assembly 20 where a bolt (not shown) acts as the pivot pin. As noted above, a biasing member (not shown) may be provided that normally biases the second jaw assembly 40 in a direction away from the first jaw assembly 20.

The handle assembly 14 houses a drive assembly and one or more electrical controls used to activate and deactivate the tool 10. In the exemplary embodiment shown, the handle assembly 14 includes a housing 100. The housing 100 is configured and dimensioned to enclose or wrap around a drive assembly and a proximal portion of the working head assembly 12. More specifically, the distal end of the housing 100 is a head portion 102 configured and dimensioned to enclose a portion of the jaw assemblies 20 and 40. An intermediate portion of housing 100 includes a user grip portion 104 that is also configured and dimensioned to enclose the drive assembly. The proximal end of the housing 100 is an end portion 106 configured and dimensioned to receive a portion of a battery 108 and to house the components used to connect the battery 108 to the housing 100 using, for example, known battery contacts. One or more operator controls may be provided including, for example, a trigger 114. Pulling trigger 114 activates the internal drive assembly causing second jaw assembly 40 to pivot towards first jaw assembly 20 and performing the crimping operation crimping a cable termination or connector to a conductor positioned between the first and second jaw assemblies 20 and 40.

As described above, many types of crimp connectors and terminations exist and come in many different shapes and sizes depending on their particular applications. The shape and size of the dies used to perform the crimps on the various types of crimp connectors and terminations also vary. An example of a crimp-type cable termination 9 is shown in FIG. 3 for illustrative and discussion purposes and may be referred to herein as cable termination 9. Of course, aspects of the present disclosure are not limited to this illustrative type of cable termination 9. Cable termination 9 includes a barrel 3 and a connector 5. Barrel 3 is dimensioned to receive a bare conductor having a specified gauge or gauge range and may or may not include a longitudinal slit 6. To attach cable termination 9 to cable 1, a portion of the insulating cover 7 of cable 1 is removed exposing bare conductor 2. For example, a sufficient length of insulating cover 7 is removed such that the bare conductor 2 can extend completely through the length of the barrel 3 of cable termination 9. The bare conductor 2 is slid into the barrel 3 of cable termination 9. Generally, for a proper connection, the bare conductor 2 is slid into the barrel 3 until the distal end 2A of conductor 2 extends completely through the barrel 3 and past distal end 8 of barrel 3 and a portion of the distal end 2A of bare conductor 2 is exposed (e.g., see FIG. 2). For an effective crimp, the barrel 3 must be properly positioned in the impinging regions 30 and 48 so that the crimp is performed at the proper position on the barrel 3 of the cable termination 9.

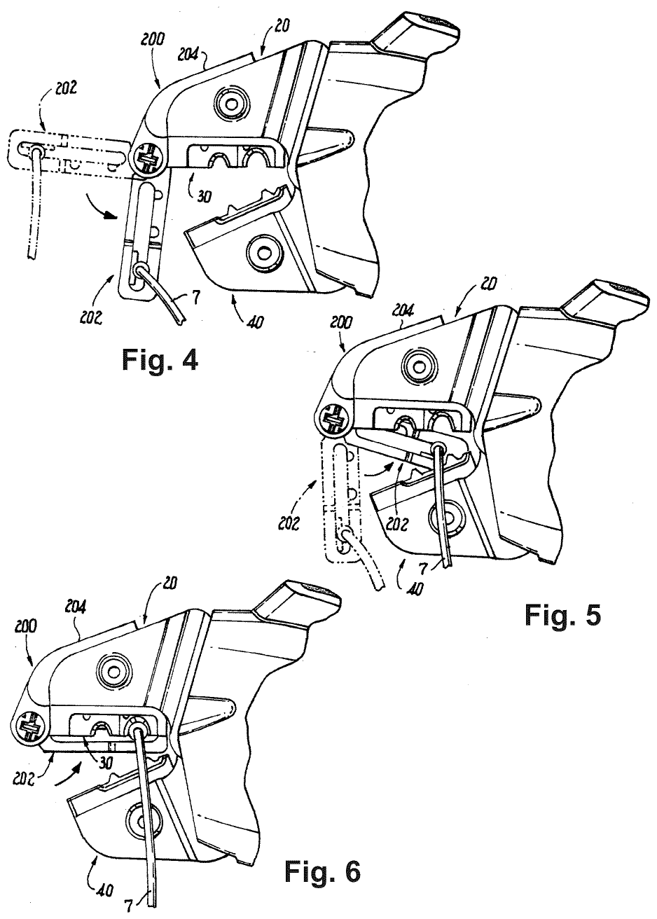

A locator plate assembly 200 according to an illustrative embodiment of the present disclosure may be mounted to the first or second jaw assembly 20, 40. Locator plate assembly 200 aids the operator of the tool 10 in the accurate placement of the cable termination and conductor during the crimping operation. According to various illustrative embodiments to be described below, the locator plate assembly 200 may be mounted to a jaw assembly in various ways. For example, according to the present illustrative embodiment, locator plate assembly 200 includes a mounting member 204 that is secured to first jaw assembly 20 in a snap fit manner. Locating plate assembly 200 includes a locator plate 202 that is pivotally attached to mounting member 204. As shown in FIGS. 4-6, the locator plate 202 can be pivoted from a non-crimping position depicted in FIG. 4 by rotating it in a counter-clockwise direction (FIG. 5) to a crimping position depicted in FIG. 6 adjacent impinging region 30. Locator plate 202 includes a longitudinal slot 202B dimensioned to receive a portion (connector 5) of the cable termination 9.

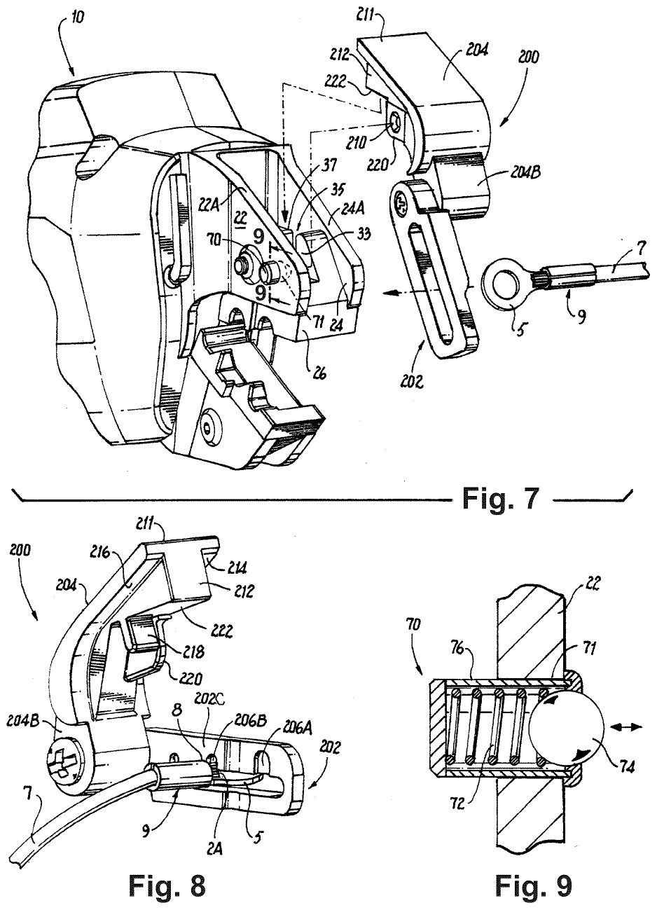

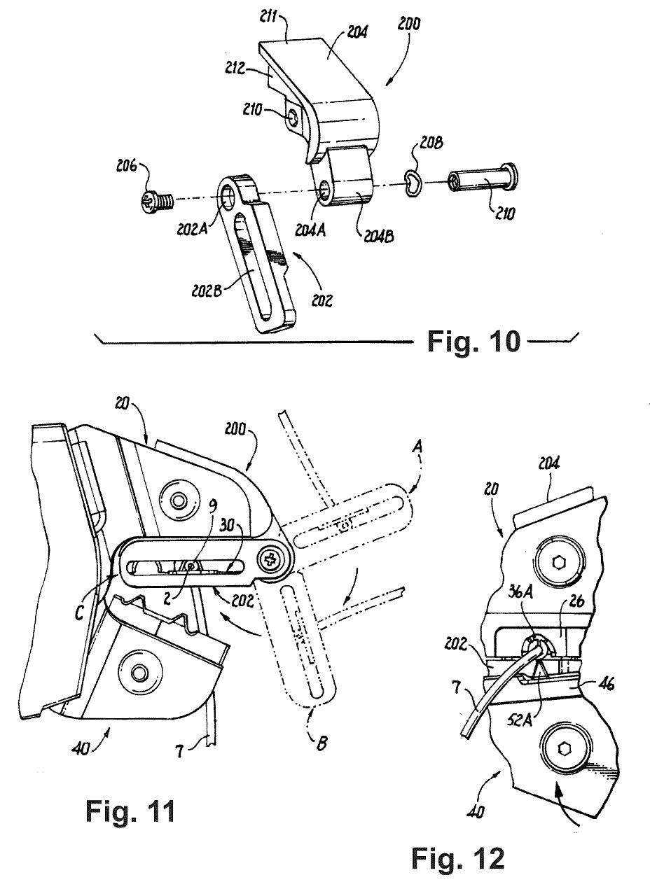

A locator plate assembly according to an illustrative embodiment of the present disclosure is shown in FIGS. 7-12 and is referred to herein as locator plate assembly or assembly 200. Locator plate assembly 200 may be removably attached to a crimping tool such as the illustrative crimping tool 10 described above. Referring to FIG. 10, locator plate assembly 200 includes a mounting member 204 and a pivoting locator plate 202. Locator plate 202 includes a pivot hole 202A and a longitudinal slot 202B. As described above, longitudinal slot 202B is dimensioned to receive and properly position a portion of a crimp connector when performing a crimp operation. One or more notches 206A-206C (see also FIG. 2) may be provided adjacent longitudinal slot 202B. Notches 206A-206C are positioned to align with the impinging regions of the tool dies. For example, according to the present illustrative embodiment, notch 206A aligns with impacting surface 36A and notch 206B aligns with impacting surface 36B of die 26. Notches 206A-206C are dimensioned for receiving and positioning the distal end 2A of conductor 2 extending from barrel 3 of crimp connector 9 (e.g., see FIGS. 2 and 3). Mounting member 204 includes a central body 212, top plate 211 and locator plate mounting member 204B extending along a longitudinal axis. Pivot hole 202A in locator plate 202 is dimensioned to receive screw 206 and binding barrel 210. Binding barrel 201 extends through spring washer 208 and hole 204A in locator plate mounting member 204B and receives screw 206. Locator plate 202 is thus pivotally connected to the mounting member 204 and has an axis of rotation about binding barrel 210/screw 206 which is perpendicular to the longitudinal axis.

The locator plate assembly 200 may be attached to the crimping tool 10 in various ways. That is, mounting member 204 may be provided in various configurations to mount the locator plate assembly 200 to the crimping tool 10. For example, the locator plate assembly 200 may be mounted to tool 10 by snapping it onto the tool utilizing a spring-loaded mechanism, by magnetically attaching it to the tool frame and/or the die, by clipping it around the die or by press-fitting it between the tool frame via a wedge or taper or may be manufactured as part of the die itself. Once the locator plate assembly 200 is attached to the crimping tool 10 utilizing any of the illustrated embodiments, the locator plate 202 can be pivoted into and out of a crimping position.

As shown in FIGS. 7-9, the central body 212 of mounting member 204 is configured to fit between first and second jaw plates 22 and 24 of tool 10 and is configured to mate with at least a portion of upper die 26 and first and second jaw plates 22 and 24. For example, the lower portion of central body 212 is configured to mate with the upper mounting region 31 of upper die 26. The upper mounting region 31 of die 26 includes a flat upper surface portion 37 upon which the lower surface portion 222 of central body 212 rests. The underside edges 214, 216 of top plate 211 are configured to rest upon the upper edges 22A, 24A of jaw plates 22, 24. To provide longitudinal and lateral support, longitudinal member 220 and lateral member 218 extend from the bottom of the central body 212 of mounting member 204 and are dimensioned and positioned to be received in longitudinal region 33 and lateral notch 35, respectively, of die 26. According to an illustrative embodiment, the bottom of the central body 212 of mounting member 204 may be keyed for use with a particular die or dies by modifying the length and/or width of the longitudinal member 218 and/or lateral member 218 to correspond to the longitudinal region 33 and/or lateral notch 35 on the specific corresponding die. According to the present illustrative embodiment, the first jaw plate 22 has an orifice 71 for receiving a ball and spring type detent 70 which includes a cup 76, spring 72 and detent ball 74 (e.g., see FIG. 9). As mounting member 204 is pressed into mounting position between the first and second jaw plates 22 and 24 and onto die 26, ball 74 is compressed against the force of spring 72. Mounting member 204 is properly and securely positioned when ball 74 snaps into dimple 210 in the side of lateral member 220 of mounting member 204. Locator plate assembly 200 can be removed from the mounting position by firmly lifting mounting member 204 from between the first and second jaw plates 22 and 24, disengaging ball 74 from dimple 210. Alternatively, one or more portions of die 26 and/or mounting member 204 may be provided with magnets. For example, detent 70 may be replaced with a magnet such as, for example, a rare earth magnet. The magnet would then be positioned to abut a portion of longitudinal member 220 (which may or may not have a magnet embedded therein) for magnetically securing the mounting member 204 to tool 10.

As described with respect to FIGS. 2 and 8, the locator plate 202 is used to ensure the crimp connector 9 and conductor 2 are properly positioned for crimping. For purposes of illustration and description, cable termination 9 is shown upside down in FIG. 2 with respect to how it is to be inserted into longitudinal slot 202B in locator plate 202 prior to crimping. In particular, the cable termination 9 and conductor 2 are properly positioned when connector 5 rests in longitudinal slot 202B of locator plate 202 and the distal end 8 of barrel 3 abuts surface 202C of the locator plate 202 and the exposed distal end 2A of bare conductor 2 rests in the properly positioned notch (206A, 206B, 206C), in this example notch 206B. Locator plate 202 may then be rotated in the counter-clockwise position (FIG. 2) until locator plate 202 is adjacent the impinging region 30 and the barrel 3 is seated in the appropriate impacting surface (e.g., impacting surface 36A).

Alternatively, the locator plate 202 may first be rotated into the crimping position adjacent impinging region 30. The bare conductor 2 is then slid into barrel 3 of cable termination 9 and the connector and conductor are then positioned such that the connector 5 is positioned within longitudinal slot 202B and the distal end 8 of barrel 3 abuts surface 202C of the locator plate 202 and the exposed distal end 2A of bare conductor 2 rests in the properly positioned notch (206A, 206B, 206C), in this example notch 206B 4.

The tool is then activated moving the impacting surfaces 36 and 52 toward each other crimping the connector 4 to the bare conductor 3. The locator plate assembly 200 insures that the crimp is performed at the proper position on the crimp connector 9 and the proper amount of the bare distal end 2A of conductor 2 is exposed.

As shown in FIGS. 11 and 12, locator plate 202 can be rotated and moved into and out of crimping position “C”. In the crimping position “C”, locator plate 202 is positioned adjacent the impinging regions 30 of die 26. In the crimping position “C”, locator plate 202 is used to properly position the cable termination 9 and bare cable 2 within barrel portion 3 of cable termination 9 (e.g., see FIGS. 2, 3) for crimping. Rotating the locator plate 202 in the counter-clockwise direction (FIG. 11) towards position “A” moves the locator plate 202 out of the crimping position so that the tool 10 can be used to crimp connectors not requiring the use of the locator plate 202. Such crimp connectors include but are not limited to, for example, butt splice connectors connecting two or more conductors end to end.

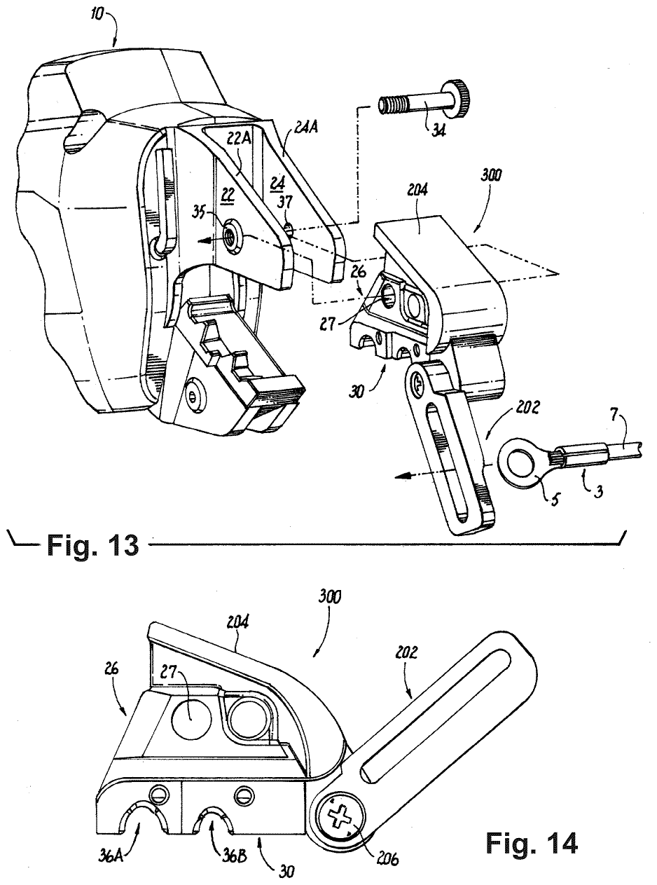

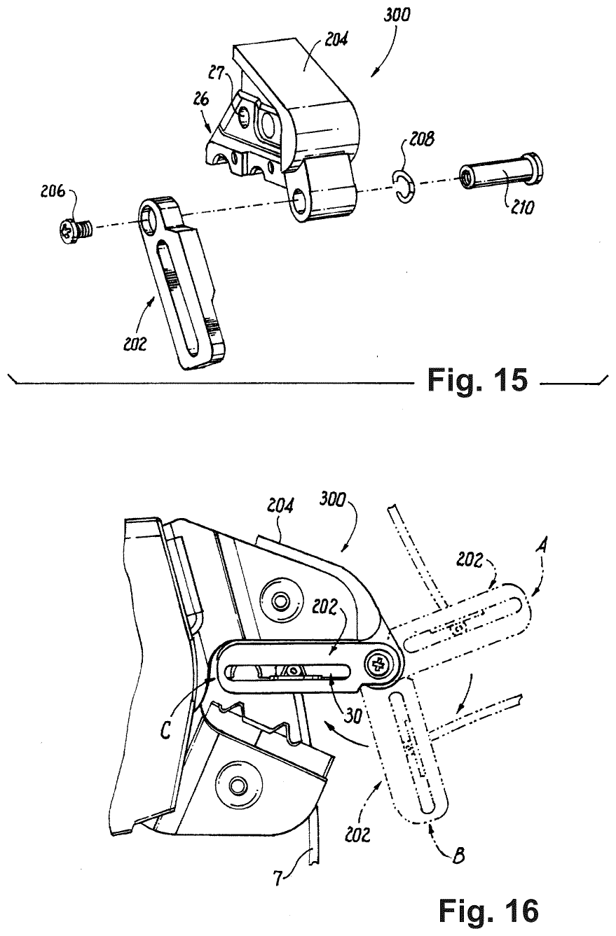

According to another illustrative embodiment of the present disclosure, the mounting member 204 is permanently connected to the die 26 as shown in FIGS. 13-16 forming a locating plate assembly/die combination 300. For example, mounting member 204 may be permanently secured to the die 26 by weld, adhesive or other attachment. Alternatively, mounting member 204 may be formed in situ during manufacture of the die 26. The locating plate assembly/die combination 300 is attached to tool 10 utilizing a bolt in a manner similar to how die 26 is attached to tool 10 above. That is, the locating plate assembly/die combination 300 includes a hole 27 extending therethrough which aligns with holes 35, 37 in first and second jaw plates 22, 24, respectively of tool 20. Hole 35 in first jaw plate 22 is threaded as shown and is positioned and dimensioned to receive bolt 34 which extends through holes 37 in second jaw plate 24 and hole 27 in locating plate assembly/die combination 300, thus securing the locating plate assembly/die combination 300 to the tool 10.

As shown in FIG. 16, locator plate 202 can be rotated and moved into and out of crimping position “C”. In the crimping position “C”, locator plate 202 is positioned adjacent the impinging regions 30 of die 26. In the crimping position “C”, locator plate 202 is used to properly position the cable termination 9 and bare cable 2 within barrel portion 3 of cable termination 9 (e.g., see FIGS. 2, 3) for crimping. Rotating the locator plate 202 in the counter-clockwise direction towards position “A” moves the locator plate 202 out of the crimping position so that the tool 10 can be used to crimp connectors not requiring the use of the locator plate 202. Such crimp connectors include but are not limited to, for example, butt splice connectors connecting two or more conductors end to end.

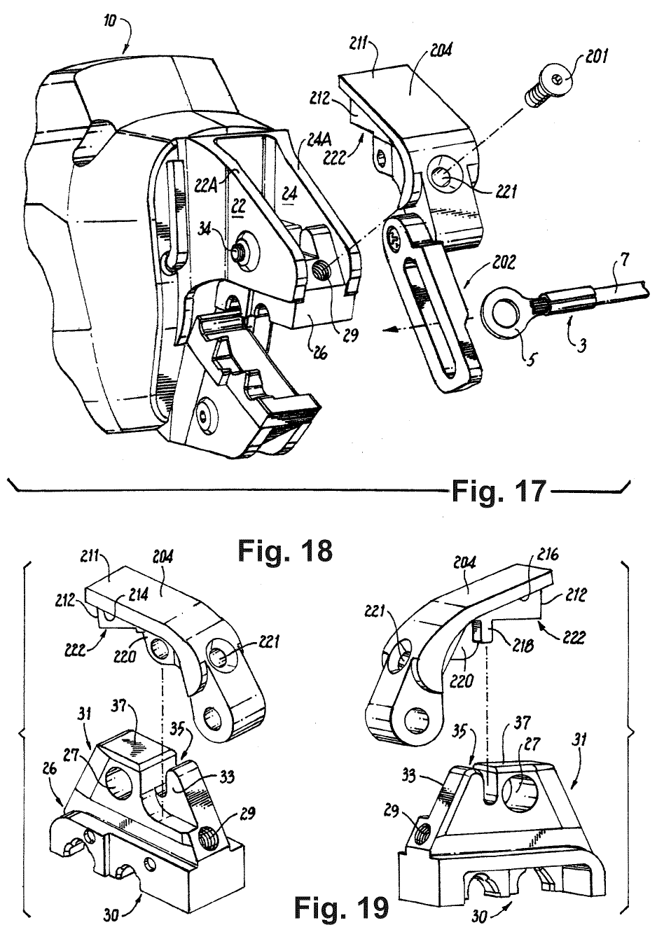

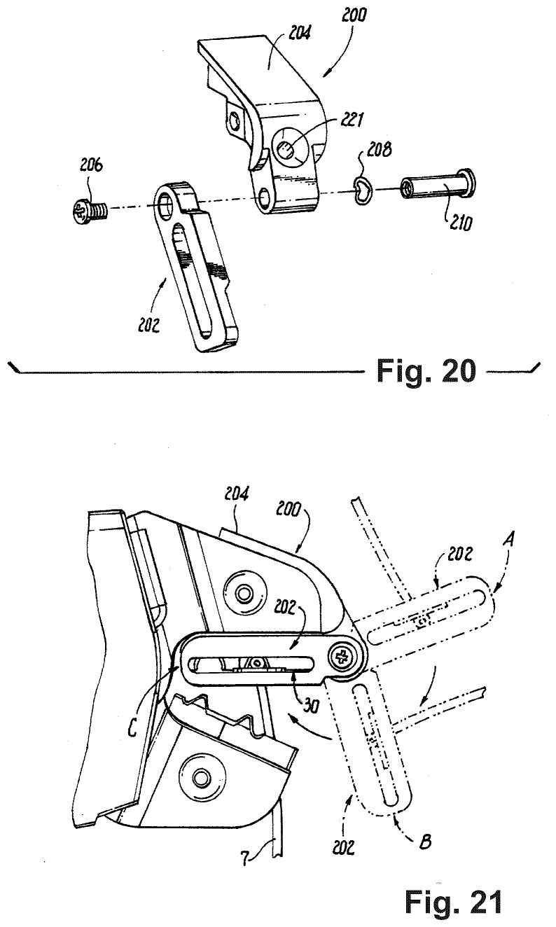

According to another illustrative embodiment of the present disclosure, the mounting member 204 is removably or semi-permanently connected to the die 26 as shown in FIGS. 17-21. For example, mounting member 204 may be secured to the die 26 by a screw, magnet or other semi-permanent type of attachment. The central body 212 of mounting member 204 is configured to fit between first and second jaw plates 22 and 24 of tool 10 and is configured to mate with at least a portion of upper die 26 and first and second jaw plates 22 and 24. For example, the lower portion of central body 212 is configured to mate with the upper mounting region 31 of upper die 26. The upper mounting region 31 of die 26 includes a flat upper surface portion 37 upon which the lower surface portion 222 of central body 212 rests. The underside edges 214, 216 of top plate 211 are configured to rest upon the upper edges 22A, 24A of jaw plates 22, 24. To provide longitudinal and lateral support, longitudinal member 220 and lateral member 218 extend from the bottom of the central body 212 of mounting member 204 and are dimensioned and positioned to be received in longitudinal region 33 and lateral notch 35, respectively, of die 26. Die 26 includes a threaded hole 29 which aligns with hole 221 in mounting member 204. The present embodiment may or may not include a detent type arrangement as described above with respect to FIGS. 7-9. Mounting member 204 is pressed into mounting position between the first and second jaw plates 22 and 24 and onto die 26. A mounting screw 201 is then passed through hole 221 in mounting member 204 and screwed into threaded hole 29 in die 26 securing the mounting member 204 to the die 26. Die 26 may be mounted between first and second jaw plates 22 and 24 utilizing a bolt (not shown) similar to that described above with respect to FIGS. 1 and 13 prior to or after attachment of mounting member 204 to the die 26. Mounting member 204 can be readily removed from the die 26 and replaced by unscrewing mounting screw 201.

As shown in FIG. 21, locator plate 202 can be rotated and moved into and out of crimping position “C”. In the crimping position “C”, locator plate 202 is positioned adjacent the impinging regions 30 of die 26. In the crimping position “C”, locator plate 202 is used to properly position the cable termination 9 and bare cable 2 within barrel portion 3 of cable termination 9 (e.g., see FIGS. 2, 3) for crimping. Rotating the locator plate 202 in the counter-clockwise direction towards position “A” moves the locator plate 202 out of the crimping position so that the tool 10 can be used to crimp connectors not requiring the use of the locator plate 202. Such crimp connectors include but are not limited to, for example, butt splice connectors connecting two or more conductors end to end.

The present disclosure provides locator plate assemblies that can be used with hand-operated and hand-held, battery powered tools including battery powered crimping tools that increase the accuracy of the crimping process.

The foregoing embodiments and advantages are merely exemplary and are not to be construed as limiting the scope of the present invention. The description of an exemplary embodiment of the present invention is intended to be illustrative, and not to limit the scope of the present invention. Various modifications, alternatives and variations will be apparent to those of ordinary skill in the art and are intended to fall within the scope of the invention.

Certain terminology may be used in the present disclosure for ease of description and understanding. Examples include the following terminology or variations thereof: top, bottom, up, upward, upper inner, outer, outward, down, downward, upper, lower, vertical, horizontal, etc. These terms refer to directions in the drawings to which reference is being made and not necessarily to any actual configuration of the structure or structures in use and, as such, are not necessarily meant to be limiting.

As shown throughout the drawings, like reference numerals designate like or similar corresponding parts. While illustrative embodiments of the present disclosure have been described and illustrated above, it should be understood that these are exemplary of the disclosure and are not to be considered as limiting. Various portions of the described embodiments may be mixed and matched depending on a particular application. Additions, deletions, substitutions, and other modifications can be made without departing from the spirit or scope of the present disclosure. Accordingly, the present disclosure is not to be considered as limited by the foregoing description.

What is claimed is:

1. A locator plate assembly for use with a crimping device, the locater plate assembly comprising:
a main body; and
a locator plate pivotally attached to the main body.

2. The locator plate assembly according to claim 1, wherein the main body is removably attached to the crimping device.

3. The locator plate assembly according to claim 2, wherein the main body is removably attached to the crimping device by at least one of a detent mechanism and a magnet.

4. The locator plate assembly according to claim 1, wherein the main body is removably attached to a crimping die for use with the crimping device.

5. The locator plate assembly according to claim 4, wherein the main body is removably attached to the crimping die by at least one of a screw and a magnet.

6. The locator plate assembly according to claim 1, wherein the main body is permanently attached to a crimping die for use with the crimping device.

7. The locator plate assembly according to claim 6, wherein the main body is permanently attached to the crimping die via weld or adhesive or is formed in situ with the crimping die.

8. The locator plate assembly according to claim 1, wherein the main body has a longitudinal axis.

9. The locator plate assembly according to claim 8, wherein the locator plate pivots about an axis perpendicular to the longitudinal axis.

10. The locator plate assembly according to 1, wherein the main body has a mating surface keyed for mating with a portion of a die specific for use with the locator plate assembly.

11. A quick release locator plate assembly for use with a crimping device, the quick release locater plate assembly comprising:
a main body configured to attach to the crimping device and comprising a quick release mechanism; and
a locator plate pivotally attached to the main body.

12. The quick release locator plate assembly according to claim 11, wherein the main body is removably attached to the crimping device.

13. The quick release locator plate assembly according to claim 12, wherein the main body is removably attached to the crimping device by at least one of a detent mechanism and a magnet.

14. The quick release locator plate assembly according to claim 11, wherein the main body is removably attached to a crimping die for use with the crimping device.

15. The quick release locator plate assembly according to claim 14, wherein the main body is removably attached to the crimping die by at least one of a screw and a magnet.

16. The quick release locator plate assembly according to claim 11, wherein the main body is permanently attached to a crimping die for use with the crimping device.

17. The quick release locator plate assembly according to claim 16, wherein the main body is permanently attached to the crimping die via weld or adhesive or is formed in situ with the crimping die.

18. The quick release locator plate assembly according to claim 11, wherein the main body has a longitudinal axis.

19. The quick release locator plate assembly according to claim 18, wherein the locator plate pivots about an axis perpendicular to the longitudinal axis.

20. The quick release locator plate assembly according to 19, wherein the main body has a mating surface keyed for mating with a portion of a die specific for use with the locator plate assembly.
